(19) United States
(12) Patent Application Publication
(10) Pub. No.: US 2014/0186500 A1
(43) Pub. Date: Jul. 3, 2014

(54) DEVICES AND METHODS FOR REDUCING THE MICROBIAL LOAD ON AN OBJECT USING A UV LIGHT SOURCE

(71) Applicant: The Regents of the University of California, Oakland, CA (US)

(72) Inventor: Sangwei Lu, Kensington, CA (US)

(21) Appl. No.: 14/139,638

(22) Filed: Dec. 23, 2013

Related U.S. Application Data
(60) Provisional application No. 61/747,122, filed on Dec. 28, 2012.

(51) Int. Cl. A23L 3/28

(52) U.S. Cl. CPC A23L 3/28
USPC 426/248; 99/451

(57) ABSTRACT

The present disclosure provides devices for reducing the microbial load on objects (e.g., edible plant matter). In certain aspects, the devices include a UV light source and at least a portion of a tumbler composed of a UV light transmissive material. Aspects of the invention also include methods for reducing the microbial load on an object using a UV light source.

### CROSS-REFERENCE TO RELATED APPLICATIONS

This application claims the benefit under 35 U.S.C. §119(e) of U.S. Provisional Application No. 61/747,122 filed on Dec. 28, 2012, the disclosures of which is herein incorporated by reference in their entirety.

### REFERENCE TO GOVERNMENT SUPPORT

This invention was made with government support under Grant No. 2006-35201-16551 awarded by the United States Department of Agriculture. The government has certain rights in the invention.

### INTRODUCTION

Modern humans are exposed to many types of bacteria in the course of their day to day lives. One major source of such exposure is the food that they consume. Food contaminated with bacteria is known to cause a variety of foodborne illnesses having severe consequences for human health.

One study estimated that each year in the United States there are 9.4 million episodes of foodborne illness. Scallan E., Hoekstra R. M., Angulo F. J., Tauxe R. V., Widdowson M.-A., Roy S. L., et al., Foodborne illness acquired in the United States—major pathogens, Emerg. Infect. Dis. 2011 January, pp. 16-22. Other studies have estimated this number to be significantly higher. Many of these episodes are linked to bacterial contamination of food and result in an estimated 55,961 hospitalizations and 1,351 deaths each year. Id.

A number of bacterial varieties often present in food, including Enterobacter, Acinetobacter, Escherichia, Klebsiella, Salmonella, Pseudomonas, and Stenotrophomonas, have been identified as having serious pathogenic potential for humans. In recent years, multiple foodborne outbreaks of bacteria including Salmonella and Escherichia coli have occurred. See, i.e., Presentation and Evaluation of the Epidemiological Findings in the EHEC 0104: H4 Outbreak, Robert Koch Institut, May/June 2011; Investigation of an Escherichia coli O157:H7 Outbreak Associated with Dole Pre-Packaged Spinach, California Food Emergency Response Team, Mar. 21, 2007. The result of such outbreaks has been severe disease and death.

Historically, the majority of foodborne illnesses were reported to be caused by contaminated animal products including dairy, chicken, beef, and ready-to-eat meat products. However, in recent years, increasing numbers of foodborne illnesses have been reported to be caused by fresh produce. Studies have confirmed the presence of a wide variety of pathogenic bacteria on commercially available produce including alfalfa sprouts. See, i.e., Loui C., Grigoryan G., Huang H., Riley L. W., Lu S., Bacterial Communities Associated with Retail Alfalfa Sprouts, J. Food Prot. Vol. 71, No. 1, 2008 January, pp. 200-204.

In light of the danger posed by bacterial contamination associated with foodborne illness, effective methods of killing bacteria associated with foods including fresh produce would make human life healthier and safer.

### SUMMARY

The present disclosure provides devices for reducing the microbial load on objects (e.g., edible plant matter). In certain aspects, the devices include a UV light source and at least a portion of a tumbler composed of a UV light transmissive material. Aspects of the invention also include methods for reducing the microbial load on an object using a UV light source.

Devices of the present disclosure, in various aspects, include a container having an interior and an exterior, a UV light source configured to illuminate at least a portion of the interior of the container, and a tumbler configured for insertion into the container and made of a UV light transmissive material. In some embodiments, the container of the device includes a UV light-reflective interior surface.

Individual components of the device may have a wide variety of different shapes. For instance, some aspects of the device include a container shaped as a rectangular box. In some embodiments in which the container of the device is shaped as a rectangular box, the UV light source is mounted to at least two interior walls of the rectangular box.

In some instances, the device includes a kinetic component configured to move the tumbler within the container. In certain aspects, a “kinetic component” is device configured to impart motion. In aspects of the device which include a kinetic component, the kinetic component may be operably coupled to a timer component configured to turn off the kinetic component after a predetermined time. Other components of the device may be operably coupled to a timer component as well. For example, in some embodiments of the device, the at least one UV light source is operably coupled to a timer component configured to turn off the UV light source after a predetermined time. Furthermore, in some embodiments of the device, the tumbler is rotatably coupled to at least two interior walls of the box.

In aspects of the device which include a kinetic component, the kinetic component may be configured for manual operation. In some embodiments in which the kinetic component is configured for manual operation, the kinetic component may be coupled to a crank component. Additionally, in some embodiments the kinetic component is configured to operate mechanically without human intervention. As such, some embodiments of the device which include a kinetic component also include a power source that is operably connected to the kinetic component. Particular aspects of the device may also include a power source operably connected to the at least one UV light source.

Specific embodiments of the device include at least one opening in the tumbler. In certain embodiments, the at least one opening is dimensioned to receive an object, as “object” is described herein, into a tumbler. Some embodiments of the device include a tumbler having a lid removably coupled to the tumbler and at least partially covering at least one opening in the tumbler. In some aspects, when the lid is coupled to the tumbler, the lid and tumbler form a water-tight cavity within the tumbler.

As noted above, components of the device may have a variety of different shapes. For instance, in certain aspects of the device, the tumbler is shaped as a cylinder having a first end and a second end and a long axis of symmetry extending from the first end to the second end and about which the tumbler is symmetrical. In some aspects of the device in which the tumbler is shaped as a cylinder having a first end and a second end and a long axis of symmetry extending from the first end to the second end and about which the tumbler is symmetrical, the tumbler also has a single opening at the first end.

The tumbler may also include a lid having a cap and removably coupled to the tumbler at the first end in certain aspects of the device. In some embodiments of the device, the cap has an open configuration and a closed configuration and when the cap is in a closed configuration, the cap, lid and tumbler form a water-tight cavity within the tumbler. The cap may also be coupled to the lid in a variety of ways including hingedly, snapedly or adhesively.

Particular embodiments of the device include a tumbler having an open configuration and a closed configuration. In particular aspects of the device in which the tumbler has an open configuration and a closed configuration, when the tumbler is in a closed configuration, the tumbler forms a water-tight and/or air tight cavity within the tumbler.

In certain aspects of the device, the tumbler has an exterior surface and a single continuous interior surface defined by a solid sheet of the UV light transmissive material. Some embodiments of the device include a tumble that is made of plastic or polymer. In certain embodiments of the device that include a tumbler that is made of plastic or polymer the tumbler is made of ethylene tetrafluoroethylene.

The device is also scalable to a variety of different sizes. For example, in certain aspects of the device, the device is configured to be lifted by an average adult human. Furthermore, certain aspects of the device may be configured to reduce the microbial load on a variety of different objects. In some embodiments of the device, the object is edible plant matter.

In some embodiments of the device, the container has a door configured to have an open configuration and a closed configuration. In certain aspects of the device in which the container has a door configured to have an open configuration and a closed configuration, when the door is in an open configuration, the interior of the container is accessible.

Also provided by the present disclosure are methods for reducing the microbial load on an object. In certain embodiments, the methods include (1) placing an object in a device that includes a container; a UV light source configured to illuminate the interior of the container; and a tumbler configured for insertion into the container and made of a UV light transmissive material; and (2) tumbling the object in the device while the object is illuminated with UV light.

In certain aspects of the methods, the UV light transmissive material is a solid layer of material having an exterior surface and an interior surface and wherein illuminating the object with UV light includes causing UV light to pass through both the exterior surface and the interior surface of the solid layer of material. In some embodiments of the methods, the methods also include killing 95% or more of bacteria present on the object.

Placing an object in the device may, in specific aspects of the methods, include opening a door on the device, removing the tumbler from the device, opening a lid on the tumbler, inserting the object into the tumbler, closing the lid on the tumbler, and inserting the tumbler into the device.

In some embodiments of the methods, tumbling the object in the device while the object is illuminated with UV light includes activating a timer component coupled to the UV light source and configured to turn off the UV light source after a predetermined time. In certain aspects of the methods, tumbling the object in the device includes activating a timer component coupled to a kinetic component operatively coupled to the tumbler and wherein the timer component is configured to turn off the kinetic component after a predetermined time.

These and other objects, advantages, and features of the invention will become apparent to those persons skilled in the art upon reading the details of the devices and methods as more fully described below.

### BRIEF DESCRIPTION OF THE FIGURES

FIG. 1 illustrates a perspective view of a device according to embodiments of the present disclosure including a tumbler and a UV light source disposed within a container.

### DETAILED DESCRIPTION

The present disclosure provides devices for reducing the microbial load on objects (e.g., edible plant matter). In certain aspects, the devices include a UV light source and at least a portion of a tumbler composed of a UV light transmissive material. Aspects of the invention also include methods for reducing the microbial load on an object using a UV light source.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and exemplary methods and materials may now be described. Any and all publications mentioned herein are incorporated herein by reference to disclose and describe the methods and/or materials in connection with which the publications are cited. It is understood that the present disclosure supersedes any disclosure of an incorporated publication to the extent there is a contradiction.

It must be noted that as used herein and in the appended claims, the singular forms “a”, “an”, and “the” include plural referents unless the context clearly dictates otherwise. Thus, for example, reference to “an opening” includes a plurality of such openings and reference to “the material” includes reference to one or more materials and equivalents thereof known to those skilled in the art, and so forth.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. To the extent such publications may set out definitions of a term that conflict with the explicit or implicit definition of the present disclosure, the definition of the present disclosure controls.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Devices

The present disclosure provides devices configured to reduce the microbial load on an object. In certain aspects, the devices include a container having an interior and an exterior, a UV light source configured to illuminate at least a portion of the interior of the container and a tumbler made of a UV light transmissive material.

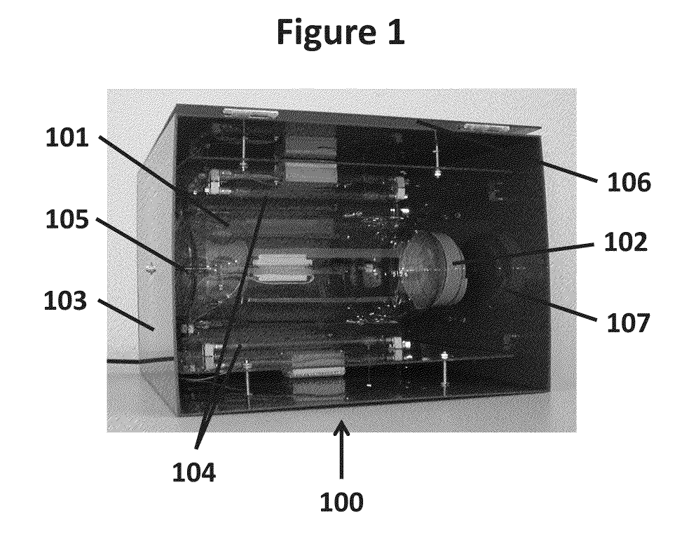

FIG. 1 illustrates one embodiment of a disclosed device 100 including a tumbler 101, a lid 102, a container 103, a UV light source 104, and other components described further below.

The phrase “reducing the microbial load”, as used herein means conducting a process that kills or eliminates a percentage of microbial life associated with (i.e., on and/or in) the target object. Reducing the microbial load may include reducing the number and/or type of microorganisms associated with an object. While the phrase “reducing the microbial load”, as used herein is described as reducing the microbial load “on” something, the word “on” is not limiting and may also mean reducing the microbial load within something. In some embodiments, the process of reducing the microbial load includes sterilizing something. The process of reducing the microbial load may include applying a particular combination of radiation, heat, pressure, or chemicals to the environment of the microbial life.

Microbial life may include, for example, bacteria, viruses, fungi, spore forms or the like and may be present, for example, on a surface or contained in a compound or fluid. More specifically, microbial life may include, for example, bacteria associated with food products, (i.e., produce). Bacteria associated with food products may include, for example, bacteria of the phylum Proteobacteria and of any order (i.e., Alphaproteobacteria, Betaproteobacteria, Gammaproteobacteria, Sphingobacteria, Flavobacteria, and/or Acidobacteria), family (i.e., Enterobacteriaceae, Oxalobacteraceae, Moraxellaceae, Pseudomonadaceae, Sphingomonadaceae, Sphingomonadaceae, Bradyrhizobiaceae, Methylophilaceae, Acetobacteraceae, Comamonadaceae, Xanthomonadaceae, Flexibacteraceae, Flavobacteriaceae, and/or Acidobacteriaceae), and/or genus (i.e., Acinetobacter, Enterobacter, Escherichia coli, Klebsiella, Pseudomonas, Salmonella and/or Stenotrophomonas). Bacteria associated with food products may include specific genera of bacteria having pathogenic potentials for humans (i.e., certain bacteria of the genera Acinetobacter, Enterobacter, Escherichia coli, Klebsiella, Pseudomonas, Salmonella, and/or Stenotrophomonas). Bacteria having pathogenic potentials for humans may potentially be harmful to human health. Specific examples of bacteria associated with food products include Escherichia coli, Salmonella (e.g., S. enterica), Shigella, and Listeria monocytogenes. Specific examples of bacteria associated with food products may, or may not be Gram-negative bacteria.

The percentage of microbial life killed or eliminated by reducing the microbial load may be 100% of the total microbial life initially present. The percentage of microbial life killed or eliminated by reducing the microbial load may be between 90% and 99.5% (i.e., between 90% and 99.0%, 99.1%, 99.2%, 99.3%, or 99.4%) of the total microbial life initially present. The percentage of microbial life killed or eliminated by reducing the microbial load may be 10% or more, 20% or more, 30% or more, 40% or more, 50% or more, 60% or more, 70% or more, 80% or more, 85% or more, 90% or more, 91% or more, 92% or more, 93% or more, 94% or more, 95% or more, 96% or more, 97% or more, 98% or more, and/or 99% or more (up to 100%) of the total microbial life initially present. The percentage of microbial life killed or eliminated by reducing the microbial load may also be 81.4%, 94.2%, 94.3%, 99.3%, and/or 99.4% of the total microbial life initially present.

Reducing the microbial load on something may make it incapable of causing infection (i.e., invasion and multiplication in body tissues to cause local cellular injury) in a subject (i.e., a living organism, such as a mammal, such as a human). In certain embodiments the subject is a “mammal” or “mammalian”, where these terms are used broadly to describe organisms which are within the class mammalia, including the orders carnivore (e.g., dogs and cats), rodentia (e.g., mice, guinea pigs, and rats), and primates (e.g., humans, chimpanzees, and monkeys). In some embodiments, subjects are humans. The term “humans” may include human subjects of both genders and at any stage of development (i.e., fetal, neonates, infant, juvenile, adolescent, adult), where in certain embodiments the human subject is a juvenile, adolescent or adult. While reducing the microbial load using the devices and methods disclosed herein may be applied to prevent infection in a human subject, it is to be understood that the subject devices and methods may also be carried-out to reduce the microbial load on something in order to make it incapable of causing infection in other subjects (that is, in “non-human subjects”).

The term “objects”, as used herein, includes one or more individual components. Such “objects” may be of a size and shape to fit partially or completely within the tumbler. For example, objects may be shaped substantially as a cuboid, a cube, a square based pyramid, a rectangular based pyramid, a cone, a triangular prism, a triangular based pyramid, a sphere, a combination thereof, or another shape. Objects may have a volume of, or be able to fit inside a cavity with a volume of, for example, 0.5 L, 1 L, 2 L, 3 L, 4 L, 5 L, 6 L, 7 L, 8 L, 9 L, 10 L, 11 L, 12 L, 13 L, 14 L, 15 L, 20 L, 25 L, 30 L, 40 L, 50 L, 100 L, 200 L, etc. Also, for example, in some embodiments, the volume of objects or cavities into which objects may fit may range from 0.001 L to 1,000,000 L. The volume of objects or cavities into which objects may fit may range, for example, from 0.001 L to 1,000,000 L. Objects or cavities into which objects may fit may have volumes in a range, for example, from 1 L to 1000 L, 1 L to 500 L, 1 L to 250 L, 1 L to 100 L, 1 L to 10 L, 0.001 L to 100, 0.001 L to 50, 0.001 L to 10 L, or 0.001 L to 1 L. Objects or cavities into which objects may fit may have volumes of a size, for example, corresponding to the volume of a quantity of food associated with one human meal, two human means, or three or more human meals. In some aspects, objects or cavities into which objects may fit may have a volume of a quantity of edible salad greens in an amount of one, two, three, four, five or ten normal human serving sizes. Objects or cavities into which objects may fit may have a volume of a quantity of food associated with restaurant food preparation. Objects may be in the form of a solid. Such objects may also be of one variety or type or more than one variety or type. For example, objects may include the combination of one or more materials and the microbial life present thereon and/or therein. The objects, in certain embodiments, are one or more substances that can be consumed to provide nutritional support for the body of the consumer (i.e., a mammal, such as a human).

By “interior”, as used herein, is meant located on the inside or related to the inner part of something. By “exterior”, as used herein, is meant located on the outside or related to the outer part of something.

By the term “illuminate”, as used herein, is meant the condition of being exposed to at least one form of radiation or the act of exposing or subjecting something to at least one form of radiation. Such exposure may be partial or complete and may last for any duration of time. As described in greater detail below, such radiation may include, for example, radiation having a wavelength commonly associated with UV radiation. The term “illuminate”, as used herein, may also mean irradiate.

The term “portion”, as used herein, means an amount, piece, fraction or section of something. The term portion, as used herein may include, for example, 100% of something.

Aspects of the disclosed device, as well as the components thereof, may include a wide variety of sizes. For example, the device may have the size of a common household kitchen appliance (i.e., a microwave, a toaster, an oven, a refrigerator, etc.). In some aspects, the device may be of a size and/or weight such that a normal adult human being can lift the device. Normal adult human beings may be able to lift a device, for example, weighing between 0.0001 mg to 90 kg. Embodiments of devices include devices or cavities therein of a set volume. For example, devices or cavities therein may have a volume corresponding to that of one, two, three, four or five servings of human food. Devices or cavities therein may also have a volume corresponding to an industrially-produced amount of human food (i.e., the quantity of food served by a restaurant in a day or a week).

Various aspects of the embodiments of the devices shall now be described in greater detail below.

Tumbler

Embodiments of the disclosed device include tumblers composed of at least one UV light transmissive material. FIG. 1 illustrates one of many possible embodiments of a tumbler 101 of the present disclosure. “UV light” (i.e., ultraviolet light) is electromagnetic radiation having a wavelength longer than the wavelength of X-rays and a wavelength shorter than the wavelength of visible light. UV light, as referred to herein, may have any wavelength range commonly associated with UV radiation. For example, UV light may have a wavelength between 10 nm to 400 nm. UV light may also have a wavelength between around 10 nm to around 380 nm. UV light may also have photon energies from 3 eV to 124 eV. UV light may also oscillate at a rate between about 800 terahertz and 30,000 terahertz.

By “transmissive”, as used herein, is meant a process or act of transmitting. As such, a “transmissive material” is a material that has the ability of transmitting (i.e., the ability of transmitting electromagnetic radiation). For example, a transmissive material may be transparent to an extent that a sufficient amount of UV light passes from a first side of the material, through the material to a second side of the material to illuminate an object on the second side of the material. Transmissive materials of interest include solid materials, and in some instances are not gaseous materials, e.g., air.

In certain aspects, a transmissive material may, for example, transmit around 100% of the radiation to which it is exposed. A transmissive material may also transmit 99% of the radiation to which the material is exposed. In such a material, the material may diffuse and/or reflect 1% of the radiation to which the material is exposed. A transmissive material may transmit between 0% and 100% of radiation to which the material is exposed. A transmissive material may also transmit, for example, between 1% and 99%, 2% and 98%, 3% and 97%, 4% and 96%, 5% and 95%, 10% and 90%, 20% and 80%, 30% and 70%, 40% and 60%, or 45% and 55% of radiation to which the material is exposed. A transmissive material may also transmit, for example, 1% or more 2% or more 3% or more 4% or more 5% or more 6% or more 7% or more 8% or more 9% or more, 10% or more, 20% or more, 30% or more, 40% or more, 50% or more, 60% or more, 70% or more, 80% or more, 85% or more, 90% or more, 91% or more, 92% or more, 93% or more, 94% or more, 95% or more, 96% or more, 97% or more, 98% or more, or 99% or more of radiation to which the material is exposed. A transmissive material may, in certain embodiments, diffuse and/or reflect the radiation to which the material is exposed but which the material does not transmit from one side of the material to the other.

By “transparent”, as used herein, is meant permeable to electromagnetic radiation of specified frequencies. “Permeable”, as used herein, refers to the capability of being passed through, especially by radiation, and is not limited to the passing through of liquids or gases. As such, a transparent material allows the passage of a specified form of radiation therethrough. For example, radiation to which one surface of transparent material is exposed will pass through the material and exit the material at an opposing surface. Such a transparent material may be permeable by only a percentage of radiation to which the material is exposed.

For example, a transparent material may be permeable by around 100% of the radiation to which it is exposed. A transparent material may also be permeable by 99% of the radiation to which the material is exposed. In such a material, the material may diffuse or reflect 1% of the radiation to which the material is exposed. A transparent material may be permeable by between 0% and 100% of radiation to which the material is exposed. A transparent material may also be, for example, permeable by between 1% and 99%, 2% and 98%, 3% and 97%, 4% and 96%, 5% and 95%, 10% and 90%, 20% and 80%, 30% and 70%, 40% and 60%, or 45% and 55% of radiation to which the material is exposed. A transparent material may also be, for example, permeable by 1% or more 2% or more 3% or more 4% or more 5% or more 6% or more 7% or more 8% or more 9% or more, 10% or more, 20% or more, 30% or more, 40% or more, 50% or more, 60% or more, 70% or more, 80% or more, 85% or more, 90% or more, 91% or more, 92% or more, 93% or more, 94% or more, 95% or more, 96% or more, 97% or more, 98% or more, or 99% or more (up to 100%) of radiation to which the material is exposed.

Examples of materials that the tumblers of the disclosed device may be composed of include polymers, ceramics and/or glasses. In some aspects, the tumblers are not composed of metal or other material that is non-transmissive and/or non-transparent to UV light. In certain aspects, materials of which tumblers are composed may be polarized or non-polarized. Specific types of materials include, i.e., ethylene tetrafluoroethylene, polyethylene terephthalate, aluminum oxynitride, borosilicate glass, poly(methyl methacrylate), polycarbonate, polyethelyne, quartz, CaF₂ and BaF₂. However, these examples are not limiting and the tumbler material may be any material, or combination of materials, having the optical and structural properties necessary to function in the disclosed device as described herein.

Certain embodiments of the disclosed device include tumblers configured for insertion into the container component of the device. As such, aspects of the tumbler may include a wide variety of shapes and sizes. For example, the at least one material of which the tumblers are composed may be shaped to have an interior and an exterior and, as such, may form a cavity within the tumblers. The cavity may be shaped and sized to receive objects for insertion into the tumblers, as described herein.

In certain embodiments, a tumbler is composed of one or more materials that form a container having an interior surface and an exterior surface, wherein the exterior surface defines the outer periphery of the container. Some aspects of tumblers may include tumblers composed of at least one sheet of UV light transmissive material forming a layer between an exterior surface of a tumbler and an interior surface of a tumbler. In some embodiments, the interior surface of a tumbler is substantially parallel to the exterior surface of a tumbler. Embodiments of tumblers include tumblers having a single continuous interior surface defined by a solid sheet of UV light transmissive material and/or a single continuous exterior surface defined by a solid sheet of UV light transmissive material. In some embodiments, the UV light transmissive material of a tumbler has a consistent thickness. In some embodiments, the UV light transmissive material of a tumbler has a varying thickness.

Tumblers may, in some aspects, be shaped generally as a cylinder. As used herein, “shaped generally as a cylinder” means having a first circular or rounded end and a second circular or rounded end separated from the first end by a body of material having a tubular shape along its defined length and separating the ends. FIG. 1 shows one of many possible embodiments of a tumbler 101 of the present disclosure which is generally shaped as a cylinder. In some aspects in which the tumblers are shaped generally as a cylinder, the body of material having a tubular shape has an axis running through its center which extends from the first end of a tumbler to the second end of the tumbler. In some aspects in which the tumblers are shaped generally as a cylinder, some or all of the edges of the tumblers where two surfaces intersect may be rounded. Such edges may be on an interior surface and/or an exterior surface of the tumblers. Also, where appropriate, by “rounded”, as used herein, is meant that an area of interest has measurable radii of curvature lying in a plane perpendicular to the area.

In certain aspects in which the tumblers are shaped generally as a cylinder, the cylinder may have a first end and a second end. The first end and second end of the tumblers may be substantially circular and may be the same size or different sizes. The first end and second end of the tumblers may also be separated by a length of material having the shape of a tube with a single defined radius along its entire length. In some embodiments in which tumblers have a circular first end and circular second end, each of the periphery of the first end and periphery of the second end define a circle having a radius. Embodiments of tumblers include tumblers in which the radius of the circular first end is the same or different as the radius of the circular second end. Embodiments of the tumblers disclosed herein have cross sectional areas that increase and/or decrease between the first and second ends of the tumblers.

In certain embodiments of tumblers shaped generally as a cylinder having a first end and a second end, the tumblers have a long axis of symmetry extending from the first end to the second end and about which the tumbler is symmetrical. The term “axis”, as used herein, is not limiting and means an axis of symmetry where appropriate. In some embodiments of tumblers in which the tumblers have a circular first end and circular second end, the axis of symmetry about which the tumblers are symmetrical extend through the center of the circular first end and the center of the circular second end. In certain aspects of tumblers having a long axis of symmetry extending from the first end to the second end, the tumblers may be symmetrical about the axis of symmetry except for an portion of the tumblers configured for attaching the tumblers to a separable portion of the tumblers such as a cap, lid and/or a component configured to attach to the tumblers. In some embodiments, tumblers are symmetrical about a single axis but for one or more aspects or components for attaching one portion of a tumbler to another portion of a tumbler (i.e., a lid and/or cap) and/or but for one or more components for attaching a tumbler to a container.

Tumblers, in particular embodiments, are shaped substantially as a cuboid, a cube, a square based pyramid, a rectangular based pyramid, a cone, a triangular prism, a triangular based pyramid, a sphere, or a combination thereof. In some aspects, the tumblers may be shaped at one end as a polygon, quadrilateral, oval, semi-circle, or other shape and shaped at the other end as the same shape or as a different shape. In embodiments of tumblers having a shape at a first end and a second end, the shapes may be separated by an elongate body of material having a defined length. Tumblers of interest include those dimensioned to hold objects, e.g., as described above.

Certain aspects of the tumblers may include tumblers having one or more openings. In some embodiments, the one or more openings are dimensioned to receive an object, as “object” is described herein, into a tumbler. In tumblers having a first end and a second end, the one or more openings may be at the first end and/or at the second end and/or between the first and second ends. As such, in certain aspects, the tumblers may have an open first end, and/or an open second end. The one or more openings may be any suitable size or shape (i.e., circle, semi-circle, oval, rectangle, square, triangle, polygon, quadrilateral, or combination thereof). The openings may be one or more slits. The openings may also be configured to allow objects to be inserted into the tumblers therethrough. Additionally, the openings may be configured for ventilation of the interior of the tumblers, irrigation of the interior of the tumblers, and/or another purpose.

Embodiments of tumblers include tumblers that have an open configuration and a closed configuration. In tumblers having an open configuration and a closed configuration, a tumbler is in an “open configuration” when one or more openings in the tumbler is exposed and an object or other material may thereby freely pass through the one or more openings. In tumblers having an open configuration and a closed configuration, a tumbler is in a “closed configuration” when one or more openings in the tumbler is covered by a portion of the tumbler or another aspect and an object or other material may therefore not freely pass through the one or more openings. In some embodiments of tumblers having an open configuration and a closed configuration, when the tumbler is in a closed configuration, the tumbler and/or the tumbler and other components form a water-tight cavity and/or an air-tight cavity within the tumbler.

In certain embodiments of the disclosed device, tumblers include one or more lids. In some aspects, the lid(s) is part of the tumbler, and in some aspects the lid(s) is a separate component from the tumbler. One of many possible embodiments of a lid 102 of the present disclosure is illustrated in FIG. 1. In some aspects, the one or more lids is continuous with the remainder of the tumbles and/or permanently affixed to the remainder of the tumbler. In some aspects the one or more lids is removably coupled to the tumblers.

Some embodiments of lids have one or more openings therethrough. The one or more openings in lids may fully or partially cover, align, overlap or correspond with one or more openings in the tumbler or remaining portion of the tumbler. In certain aspects, a lid may have an opening that covers, aligns, overlaps or corresponds with an opening in a tumbler but has a smaller area than the opening of the tumbler. The one or more openings in various embodiments of lids may be any suitable size or shape (i.e., circle, semi-circle, oval, rectangle, square, triangle, polygon, quadrilateral, or combination thereof). The openings also may be one or more slits. In some embodiments, an opening in a lid may have a periphery of material encompassing it which defines the opening's outer edges and extends perpendicularly to the plane defined by the outermost edge of the opening.

In aspects of tumblers in which the lid is coupled to the tumblers, the lid may be snappedly, screwedly, hingedly and/or adhesively attached to the tumblers. As such, lids may be fully or partially detachable from the remaining portions of a tumbler. In embodiments in which the lid is configured for screwedly attaching to tumblers, the lid and the remainder of the tumblers each have a separate reciprocal aspect configured to mate and thereby screwedly attach the lid and the remainder of the tumblers. In some embodiments in which the lid is hingedly coupled to the tumbler or the remaining portions of the tumbler, the lid may have a first configuration, which is a closed configuration and a second configuration, which is an open configuration.

In certain embodiments, there may be a seal between the lid and the remaining portions of the tumbler. Such a seal may be a water-tight seal and/or an air-tight seal. As such, in some embodiments, when the lid is coupled to the tumbler, the lid and tumbler form a water-tight and/or air-tight cavity within the tumbler.

In some embodiments, the lid may fully or partially cover at least one opening in the tumbler. For example, a lid may be coupled to the remaining portion of a tumbler at a first end and thereby fully or partially cover an opening in the tumbler at the first end. In aspects of tumblers having a lid, the lid may be configured to be opened to expose at least one opening and allow passage of at least one object, as described herein, therethrough. Some embodiments of lids are configured to be closed to seal at least one opening in the tumbler and to prevent passage of at least one object, as described herein, therethrough.

Lids may be composed of the same material as the remainder of the tumbler or of a different material. For example, lids may be composed of metal, glass, wood, plastic or other polymer that may, or may not be transmissive to UV light. Additionally, the means by which the lids are attached to the remainder of the tumbler may be composed of the same material as the remainder of the tumbler or of a different material and, as such, may be transmissive to UV light or non-transmissive to UV light.

Certain embodiments of the disclosed device include one or more caps. In some aspects, a cap may be part of a tumbler and/or a lid, regardless of how a cap is attached to the tumbler and/or lid. In some aspects, the cap is continuous with the remainder of the lid and/or tumblers and/or permanently affixed to the remainder of the lid and/or tumblers. In some aspects the cap is removably coupled to the lid.

In aspects of tumblers in which the cap is coupled to the lid, the cap may be snapedly, screwedly, hingedly and/or adhesively attached to the lid. As such, caps may be fully or partially detachable from the lid. In embodiments in which the cap is configured for screwedly attaching to the lid, the cap and the lid each have a separate reciprocal aspect configured to mate and thereby screwedly attach the cap and the lid.

In some aspects of caps, the caps correspond with and cover at least one opening in a lid. In some embodiments, caps are of a size and shape to cover and/or seal at least one opening in a lid. In some embodiments in which the cap is coupled to the lid, the cap may have a first configuration, which is a closed configuration and a second configuration, which is an open configuration. In such an embodiment, the cap may cover and/or seal at least one opening in the lid when in a closed configuration and not cover and/or seal at least one opening in a lid when in an open configuration. In certain embodiments in which the cap has a first configuration, which is a closed configuration and a second configuration, which is an open configuration, the cap, lid and tumbler form a water-tight cavity within the tumbler when the cap is in a closed configuration.

Particular aspects of caps may include lids that extend at least partially into at least one opening in a lid. In some aspects of caps, caps may have at least one opening or cavity into which a portion of a lid may extend. In certain embodiments, there may be a seal between the cap and the lid. Such a seal may be a water-tight seal and/or an air-tight seal.

In some embodiments, one surface of a cap has a periphery of material that extends perpendicularly to the surface. Such a periphery of material may correspond and interlock with a periphery of material encompassing an opening in a lid which defines the opening's outer edges and extends perpendicularly to the plane defined by the outermost edge of the opening. In some embodiments, the periphery of material on a cap corresponds with a periphery of material on a lid by forming a cavity into which the periphery of material on the lid may extend. In some embodiments, the periphery of material on a lid corresponds with a periphery of material on a cap by forming a cavity into which the periphery of material on the cap may extend.

Caps may be composed of the same material as the remainder of the tumbler or lid or of a different material. For example, caps may be composed of metal, glass, wood, plastic or other polymer that may, or may not be transmissive to UV light. Additionally, the means by which the caps are attached to lids or remainder of the tumbler may be composed of the same material as the remainder of the tumbler or of a different material and, as such, may be transmissive to UV light or non-transmissive to UV light.

In some aspects, tumblers may be removably coupled to one or more liners. Such liners may be configured for insertion into a cavity in a tumbler and may align or be flush with the interior surface of a tumbler. In some embodiments, liners may be configured to prevent one or more materials of the tumbler from being contaminated or damaged by one or more objects within the tumbler. In certain embodiments, liners are configured for insertion and removal through one or more openings in a tumbler. A liner may be composed of any of the UV transmissive materials that a tumbler may be composed or of another UV transmissive material. A liner may be rigid or pliable. In some aspects, liners are disposable.

Various embodiments of tumblers also optionally include at least one component for coupling to a kinetic component. The at least one component for coupling a tumbler to a kinetic component may have any suitable size or shape (i.e., a circular track or gear having teeth extending therefrom) and may be the same component or a different component for coupling a tumbler to a container or other component. The at least one component for coupling a tumbler to a kinetic component may be configured to allow the kinetic component to cause the tumbler to move (i.e., rotate) within a container.

In some embodiments of the disclosed device, the tumbler is coupled to the container. Some aspects include a tumbler that is removably and/or rotatably coupled to the container (e.g., coupled to at least two interior walls of the container). As such, tumblers may include at least one coupling component for coupling to the containers.

Select embodiments of coupling components on a tumbler may be shaped substantially as a cuboid, a cube, a square based pyramid, a rectangular based pyramid, a cone, a triangular prism, a triangular based pyramid, a sphere, a cylinder, or a combination thereof. For instance, coupling components may be shaped, partially or fully, as a circular track or gear having teeth extending therefrom. Coupling components on a tumbler may be configured to mate with one or more opposing coupling components affixed to the container and thereby couple the tumbler to the container. In certain embodiments, coupling components are configured such that the tumbler may move (i.e., rotate) within the container when the tumbler is coupled to the container.

For example, coupling components may be one or more cylindrical rods affixed to the tumbler that mate with opposing coupling components on the container. FIG. 1 illustrates one of many possible embodiments of a coupling component 105 of the present disclosure that is shaped as a cylindrical rod. Where coupling components are one or more cylindrical rods affixed to the tumbler, one rod may extend from the exterior surface of a first end of a tumbler along a central axis while another rod extends at a second end of the tumbler along the same axis. The first or second end of the tumbler may also include a lid and/or a cap to which one or more rods may optionally be attached.

Coupling components may also be any other component configured to attach a tumbler to a container and optionally, to allow the tumbler to move within the container (i.e., one or more magnets). Coupling components may also be rigid.

In some aspects, coupling components may be made of any suitable material or combination of materials. For example, coupling components may be composed of the same material as the remainder of the tumbler or lid or of a different material. For example, coupling components may be composed of metal, glass, wood, plastic or other polymer that may, or may not be transmissive to UV light.

In some embodiments of the disclosed device, the tumbler is not coupled to the container. For example, in some aspects, the tumbler is configured for insertion into the container and retained therein by resting on a layer of material (i.e., a holder such as a shelf). In certain aspects, tumblers do not include coupling components for coupling to the containers. In certain aspects in which the tumbler is not coupled to the container, the tumbler may be configured, for example, as a tray or box sized and shaped to retain one or more objects and/or to be received into the container.

As noted above, aspects of the tumbler of the disclosed device may include a wide variety of sizes. For example, the tumbler may be sized to fit inside a common household kitchen appliance (i.e., a microwave, a refrigerator, etc.). In some aspects, the tumbler may be of a size and/or weight such that a normal human being can lift the tumbler. Embodiments of tumblers include tumblers or cavities therein of a set volume. For example, tumblers or cavities therein may have a volume of 0.5 L, 1 L, 2 L, 3 L, 4 L, 5 L, 6 L, 7 L, 8 L, 9 L, 10 L, 11 L, 12 L, 13 L, 14 L, 15 L, 20 L, 25 L, 30 L, 40 L, 50 L, 100 L, 200 L, etc. Also, for example, the volume of tumblers or cavities therein may range from 0.001 L to 1,000,000 L. The volume of tumblers or cavities therein may range, for example, from 0.001 L to 1,000,000 L. Tumblers or cavities therein may have volumes in a range, for example, from 1 L to 1000 L, 1 L to 500 L, 1 L to 250 L, 1 L to 100 L, 1 L to 10 L, 0.001 L to 100, 0.001 L to 50, 0.001 L to 10 L, or 0.001 L to 1 L. Tumblers or cavities therein may have volumes of a size wherein the tumbler can hold at least one object for reducing the microbial load in a residential setting (e.g., a quantity of food associated with one human meal, two human means, or three or more human meals). In some aspects, tumblers or cavities therein may have volumes of a size wherein edible salad greens in an amount of one, two, three, four, five or ten normal human serving sizes may fit. Tumblers or cavities therein may have volumes of a size wherein the tumbler can hold at least one object for reducing the microbial load in an industrial setting (e.g., a quantity of food associated with restaurant food preparation).

UV Light Source

Embodiments of the disclosed device include a UV light source configured to illuminate the interior of a container. As noted above, by “UV light”, which is an abbreviation for ultraviolet light, as used herein, is meant electromagnetic radiation having a wavelength longer than the wavelength of X-rays and a wavelength shorter than the wavelength of visible light. By “illuminate” is meant to expose to radiation (i.e., UV radiation).

In some aspects, the UV light source is one or more UV light bulbs. In certain embodiments, the UV light bulbs include at least one means for attaching the UV light source to another material (e.g., a material of the container). In some aspects, the UV light source is one or more black lights (e.g., lamp that emits long-wave UVA radiation), short-wave UV lamps (e.g., lamp that emits short-wave UV radiation), gas-discharge lamp, UV light-emitting diodes (LEDs), UV lasers, or a combination thereof.

The UV light source is, in certain embodiments, a UV lamp of a type commonly used for ultraviolet germicidal illumination or irradiation (UVGI). UVGI is a method of disinfection that utilizes UV light having a sufficiently short wavelength to kill microorganisms.

In particular aspects, the UV light source emits short range UV light, also called (UVC). Short range UV light may have a wavelength, for example, of 254 nm or of 185 nm. Short range UV light may have a wavelength, for example, in the range of 280 nm to 100 nm, which corresponds to an energy per photon of 4.43 eV to 12.4 eV.

Embodiments of the UV light source include one or more connecting components for connecting the UV light source to a power source. The one or more connecting components may include wires, rods, electrodes or other suitable conductive and/or non-conductive materials.

The UV light source includes, in some embodiments, one or more connecting components for operably connecting the UV light source to a timer. The one or more connecting components may include wires, rods, electrodes or other suitable conductive and/or non-conductive materials. In some aspects, the timer may be configured to turn off the UV light source on and/or off after a predetermined time.

Container

The disclosed device includes, in certain aspects, a container having an interior and an exterior. In particular embodiments, the container can have a wide variety of shapes and sizes.

For example, in some aspects, the container may be shaped to have an interior and an exterior and, as such, may form at least one cavity within the container. The at least one cavity may be shaped and sized to receive articles for insertion into the container (e.g., objects and/or tumblers), as described herein.

In certain aspects, containers may be shaped generally as a cuboid or rectangular box. In embodiments in which containers are shaped as a cuboid or rectangular box, the containers include six interior faces and/or six exterior faces and each interior and/or exterior face has an opposing interior and/or exterior face with which it is parallel. In such embodiments, each face may be a wall of a rectangular box. In embodiments in which containers are shaped as a cuboid or rectangular box, containers include six planar sides, each having an exterior surface and an interior surface. In certain aspects, containers having six planar sides have three pairs of two parallel sides. For example, a container may include a first side parallel with a second side, a third side parallel with a fourth side and/or a fifth side parallel with a sixth side.

One half of the container, in certain aspects, is symmetrical with the other half of the container (e.g., top half is symmetrical with bottom half). In certain aspects, one half of an exterior surface of the container is symmetrical with the other half of the exterior surface of the container. Embodiments of containers include containers that are symmetrical with respect to two and/or three planes that lie partially within or bisect the container and containers having an exterior surface that is symmetrical with respect to two and/or 3 three planes that lie partially within the container. In some aspects in which the containers are shaped generally as a cuboid, some or all of the edges of the tumblers where two surfaces intersect may be rounded or may be at right angles. Such edges may be on an interior surface and/or an exterior surface of the containers.

Embodiments of cuboid-shaped containers also include containers having a first end (e.g., defined by a first face of material) and a second end (e.g., defined by a second face of material parallel to the first face of material) and a cross sectional area that is the same at the first end, the second end and between the first and second end. Containers may also have cross sectional areas that increase and/or decrease between the first and second ends of the containers.

In certain embodiments, containers are shaped substantially as a cuboid, a cube, a square based pyramid, a rectangular based pyramid, a cone, a triangular prism, a triangular based pyramid, a sphere, or a combination thereof. In some aspects, the containers may be shaped at one end as a polygon, quadrilateral, oval, semi-circle, or other shape and shaped at the other end as the same shape or as a different shape. In embodiments of containers having a shape at a first end and a second end, the shapes may be separated by an elongate body of material having a defined length.

As noted above, containers, in some aspects, may include one or more layers of material. Each layer may have an interior surface and an exterior surface and be affixed to another layer snapedly, adhesively or by another means. Layers of material may have a consistent thickness throughout the container or have a varying thickness throughout the container.

In some embodiments, the one or more layers of material of a container define an exterior surface and an interior surface of the container. In some embodiments (e.g., when the container is shaped as a cuboid), the flat faces of the exterior surface of the container are parallel with the flat faces of the interior surface of the container. In some embodiments, the faces of the exterior surface of the container are non-parallel with the faces of the interior surface of the container. As such, in some embodiments, the exterior surface of a container may have the same shape or a different shape than the interior surface of a container. For example, the exterior and interior surfaces may both have the shape of a cuboid or rectangular box. The volume defined by the interior surface of a container may, in some aspects, be smaller than the volume of the container itself.

Containers, in particular embodiments, include layers of material inside the exterior surface of the containers that divide the interior of the container into a plurality of cavities. For example, there may be dividing layers of material within the exterior surface of a container that separates the volume inside the container into a cavity configured for receiving a tumbler, a separate cavity for housing a UV light source and a separate cavity for housing a kinetic component, as “kinetic component” is defined below. The dividing layers of material may be transmissive to UV light and/or non-UV light transmissive. Dividing layers of material may separate any of the components, or any combination of components, of the disclosed device described herein (e.g., timer, UV light source) into separate cavities within the container.

Certain aspects of the containers may include containers having one or more openings. In containers having a first end and a second end, the one or more openings may be at the first end and/or at the second end and/or between the first and second ends. As such, in certain aspects, the containers may have an open first end, and/or an open second end. The one or more openings may be any suitable size or shape (i.e., circle, semi-circle, oval, rectangle, square, triangle, polygon, quadrilateral, or combination thereof). The openings may be one or more slits. The openings may also be configured to allow articles (e.g., objects and/or tumblers) to be inserted into the containers therethrough. Additionally, the openings may be configured for ventilation of the interior of the containers, irrigation of the interior of the containers, and/or another purpose.

In some embodiments, containers may include one or more doors (e.g., two, three, four or five doors). The door may, in certain aspects, be composed of the same or a different material or materials than the rest of the container. The door may have three edges or four or more edges which define the area of the door. In particular aspects, the area of the door may be the same as or overlap with the area defined by one or more surfaces, faces, sides, and/or openings of a container. For example, a door may be an entire side of a container shaped as a rectangular box. In some embodiments, a door is substantially planar. The door may be any suitable size or shape (i.e., circle, semi-circle, oval, rectangle, square, triangle, polygon, quadrilateral, or combination thereof). For example, a door may be of a size such that any tumbler described herein could be passed through the door or an opening in a container exposed by opening the door.

In certain aspects, the one or more doors of the container may be coupled to the container or the remainder of the container or a portion of a container other than the door. In aspects of containers in which the door is coupled to a separate portion of the container, the door may be snapedly, screwedly, hingedly and/or adhesively attached to the separate portion of the container. For example, a door may be one side or face of material of a rectangular box-shaped container hingedly connected to the remaining portions of the container that hingedly swings upward on the device and hingedly swings downward to return to its original position. FIG. 1 illustrates one of many possible embodiments of a door 106 of the present disclosure that is hinged connected to the remaining portions of the container. Doors may be fully detachable (e.g., removably coupled to) or partially detachable from the remaining portions of a container. In embodiments in which the door is configured for screwedly attaching to a separate portion of the container, the door and the separate portion of the container each have a separate reciprocal aspect configured to mate and thereby screwedly attach the door and the separate portion of the container.

In some aspects in which the door is coupled (e.g., hingedly coupled) to a separate portion of the container, the door may have a first configuration, which is a closed configuration and a second configuration, which is an open configuration. In a container having a door with an open configuration, the door is in an open configuration when the interior of the container (e.g., one or more interior surfaces of a cavity within a container) are accessible. The interior of a container is accessible when solid and/or liquid articles (e.g., objects, materials) may freely pass into and out of the interior of the container. In certain embodiments of containers having a door with an open configuration and a closed configuration, the door is configured to move from an open configuration to a closed configuration and/or a closed configuration to an open configuration. In various aspects, doors are configured to slide and/or swing from a closed to an open configuration and back to a closed configuration.

In a container having a door with an open configuration, the door is in an open configuration when the interior of the container (e.g., one or more interior surfaces of a cavity within a container) are not accessible. The interior of a container is not accessible when solid and/or liquid articles (e.g., objects, materials) may not freely pass into and out of the interior of the container.

In some embodiments, a container having a door with open and closed configurations, the door is in a closed configuration when the door covers and/or seals (e.g., seals to prevent passage of water and/or air and/or UV radiation) one or more openings in the container. In such aspects, a door is in an open configuration when the door does not cover and/or seal (e.g., seals to prevent passage of water and/or air and/or UV radiation) the same one or more openings in the container.

Embodiments of doors include doors that have a coupling component for holding a door in an open configuration, a closed configuration or somewhere between an open and closed configuration. For example, a door may include a latch, such as a latch that rotates about a fixed point, which engages another portion of a container and holds the door in a closed configuration. In some embodiments, the coupling component includes a magnet. Additionally, doors, in certain aspects, may be attached to biasing members or springs that are biased to hold the door in an open and/or closed configuration. In some aspects, doors may also include one or more handles or buttons that may be in any shape disclosed herein for moving the door from one configuration to another configuration.

As noted above, in some embodiments of the disclosed device, the container is coupled to the tumbler. Some aspects include a tumbler that is removably and/or rotatably coupled to the container (e.g., coupled to at least two interior walls of the container). As such, containers may include at least one coupling component for coupling to the tumblers.

Some embodiments of coupling components on a container may be shaped substantially as a cuboid, a cube, a square based pyramid, a rectangular based pyramid, a cone, a triangular prism, a triangular based pyramid, a sphere, a cylinder, or a combination thereof. For instance, coupling components may be shaped, partially or fully, as a circular track or gear having teeth extending therefrom. Coupling components on a container may be configured to mate with (e.g., snapedly engage) one or more opposing coupling components affixed to a tumbler and thereby couple the container to the tumbler. In certain embodiments, coupling components are configured such that the tumbler may move (i.e., rotate) within the container when the tumbler is coupled to the container.

For example, coupling components may be one or more receptacles affixed to the container for receiving one or more cylindrical rods affixed to the tumbler. Such receptacles may mate with opposing coupling components on the tumbler. Coupling components may be, for example, one or more openings on one or more surfaces of the container for receiving one or more cylindrical rods affixed to the tumbler. Coupling components may also be any other component configured to attach a container to a tumbler and optionally, to allow the tumbler to move within the container (i.e., one or more magnets). Coupling components may also be rigid (i.e., have the structural inflexibility necessary for supporting the tumbler within the container).

In some aspects, coupling components may be made of any suitable material or combination of materials. For example, coupling components may be composed of the same material as the remainder of the tumbler or lid or of a different material. For example, coupling components may be composed of metal, glass, wood, plastic or other polymer that may, or may not be transmissive to UV light.

Embodiments of containers include containers having one or more coupling components mounted on one or more interior surfaces of the containers. For example, containers shaped as a cuboid or rectangular box may have one coupling component mounted on a first face of an interior surface of a container and another coupling component mounted on a second face of an opposing interior surface that is parallel with the first face.

In some aspects, containers also may include one, two, three, four or five or more coupling components affixed to a door of the container. As such, embodiments of containers include containers that do not have any coupling components affixed to the door of the device.

In some embodiments of the disclosed device, the container is not coupled to the tumbler. For example, in embodiments of the disclosed device in which the container is not coupled to the tumbler, the tumbler and/or one or more objects may be set into the container and retained therein by resting on a shelf or other component.

Particular embodiments of the disclosed device include a container having one or more holders configured for retaining the tumbler and/or one or more objects within the container. The holder may be configured to receive directly (i.e., in the absence of a tumbler) one or more objects inserted into the container. The holder may be composed of one material or a combination of materials. The holder may be composed, partially or completely, of a UV transmissive material. The holder may also have a wide variety of shapes and sizes. For example, the holder may be shaped as one or more shelves, boxes, and/or trays. The holder may also include one or more attaching components for affixing (i.e., fixedly or removably attaching) the holder to the remainder of the container and/or device.

In various embodiments, the container is composed of at least one material. Examples of materials that the container of the disclosed device may be composed of include plastic or other polymer, metal, wood, ceramic and glass. In certain embodiments, the container is composed of one or more materials that are not transmissive to UV and/or visible light. In certain embodiments, the container is composed of one or more materials that are transmissive to UV and/or visible light. In certain embodiments, the container is composed of one or more materials that are commonly utilized in kitchen appliances (e.g., metal and plastic). One or more of the materials of the container may be non-conductive. One or more of the materials of the container may be conductive. In certain aspects, the container may include wiring composed of conductive material and used for conducting electricity. However, these examples are not limiting and the tumbler material may be any material, or combination of materials, having the structural, conductive and optical properties necessary to function in the disclosed device as described herein.

In some aspects, the container of the disclosed device may have one or more interior surfaces that are UV light-reflective. By “reflective”, as used herein, is meant that a wave (e.g., a wave of electromagnetic radiation) traveling within a first media changes direction at a boundary between the first media and a second media (e.g., a reflective material) so that the wave moves back in a different direction in the first media. Reflection, as used herein, may refer to specular reflection in which light (e.g., a ray of light) from a single incoming direction is reflected by an article into a single outgoing direction. In some aspects, a UV light-reflective material may not be UV light transmissive.

A reflective material (e.g., a UV light-reflective material), in some embodiments, reflects only a percentage of radiation to which the material is exposed. For example, a reflective material may reflect around 100% of the radiation to which it is exposed. A reflective material may also reflect 99% of the radiation to which the material is exposed. In such a material, the material may diffuse or be transmissive or transparent to 1% of the radiation to which the material is exposed. A reflective material, in some aspects, may reflect between 0% and 100% of the radiation to which the material is exposed. A reflective material may reflect between 1% and 99%, 2% and 98%, 3% and 97%, 4% and 96%, 5% and 95%, 10% and 90%, 20% and 80%, 30% and 70%, 40% and 60%, or 45% and 55% of the radiation to which the material is exposed. In some embodiments, the material may diffuse or be transmissive or transparent to the percentage of radiation not reflected. A reflective material may also reflect, for example, 1% or more 2% or more 3% or more 4% or more 5% or more 6% or more 7% or more 8% or more 9% or more, 10% or more, 20% or more, 30% or more, 40% or more, 50% or more, 60% or more, 70% or more, 80% or more, 85% or more, 90% or more, 91% or more, 92% or more, 93% or more, 94% or more, 95% or more, 96% or more, 97% or more, 98% or more, or 99% or more (up to 100%) of the radiation to which the material is exposed.

Examples of UV light-reflective materials that the containers of the disclosed device may be composed of or affixed to include one or more layers of metal, plastic or other polymer, ceramic, glass or a combination thereof. UV light-reflective materials, in some embodiments, also include one or more mirrors or materials having mirrored qualities (e.g., water).

Embodiments of containers include containers having one or more interior surfaces that are composed of or coated in a UV light-reflective material. For example, in a container shaped as a cuboid or rectangular box and having at least one internal cavity shaped as a cuboid or rectangular box, the six faces corresponding with the interior surface of the cavity may be composed of or coated in a UV light-reflective material (e.g., a mirror). One of many possible embodiments of a container of the present disclosure having one or more interior surfaces that are composed of or coated in a UV light-reflective material 107 is shown in FIG. 1.

In some embodiments, containers include one or more UV light-reflective materials that make up or are affixed to layers of material inside the exterior surface of the containers that divide the interior of the container into a plurality of cavities. In certain aspects, containers may include one or more UV light-reflective materials within one or more cavities within the container but not include UV light-reflective materials in the remaining cavities.

As noted above, aspects of the container of the disclosed device may include a wide variety of sizes. For example, the container may have the size of a common household kitchen appliance (i.e., a microwave, a refrigerator, etc.). In some aspects, the container may be of a size and/or weight such that a normal human being can lift the container. In certain aspects, containers or cavities therein are of a size such that at least one tumbler, as described herein may fit inside the container or cavity therein. Embodiments of containers include containers or cavities therein of a set volume. For example, containers or cavities therein may have a volume of 0.5 L, 1 L, 2 L, 3 L, 4 L, 5 L, 6 L, 7 L, 8 L, 9 L, 10 L, 11 L, 12 L, 13 L, 14 L, 15 L, 20 L, 25 L, 30 L, 40 L, 50 L, 100 L, 200 L, etc. Also, for example, the volume of containers or cavities therein may range from 0.001 L to 1,000,000 L. The volume of containers or cavities therein may range, for example, from 0.001 L to 1,000,000 L. Containers or cavities therein may have volumes in a range, for example, from 1 L to 1000 L, 1 L to 500 L, 1 L to 250 L, 1 L to 100 L, 1 L to 10 L, 0.001 L to 100, 0.001 L to 50, 0.001 L to 10 L, or 0.001 L to 1 L. Containers or cavities therein may have volumes of a size wherein the container can hold at least one object for reducing the microbial load in a residential setting (e.g., a quantity of food associated with one human meal, two human means, or three or more human meals). In some aspects, containers or cavities therein may have volumes of a size wherein edible salad greens in an amount of one, two, three, four, five or ten normal human serving sizes may fit. Containers or cavities therein may have volumes of a size wherein the container can hold at least one object for reducing the microbial load in an industrial setting (e.g., a quantity of food associated with restaurant food preparation).

Kinetic Component

In certain aspects, the disclosed device includes one or more kinetic components. Embodiments of kinetic components are configured to move a tumbler within a container, as a tumbler and container are described herein. For example, a kinetic component may be configured to rotate, rock or vibrate a tumbler, or a portion of a tumbler, within the container.

As such, a kinetic component may be any device configured to impart motion to another component in the manner described herein. Embodiments of kinetic components include kinetic components configured for manual operation (e.g., hand-cranked) and/or configured to operate mechanically without human intervention. By “manual operation”, as used herein, is meant operation resulting from at least one human moving a component and without the use of electricity (i.e., cranking a hand-crank). For example, a kinetic component may include or be coupled to one or more motors (e.g., electric motors), engines and/or manually-powered crank components. A kinetic component may also be, for example, a pump or vacuum.

In some embodiments, kinetic components are unidirectional (i.e., the kinetic component is configured to exert force on another component in only one direction). In some embodiments, kinetic components are bidierectional (i.e., the kinetic component is configured to exert force on another component in only two directions). In some embodiments, kinetic components are neither unidirectional or bidierectional.

In various aspects, kinetic components are operably connected to one or more power sources. By “operably connected”, as used herein, is meant connected in a specific way that allows the disclosed device and its various components to operate effectively in the manner described herein. For example, a kinetic component operably connected to a power source would allow the kinetic component to operate to impart motion to another component and/or allow the power source to provide power the kinetic component. As such, embodiments of kinetic components include one or more components (e.g., wires, electrodes) for connecting the kinetic component (e.g., electric motor) to a power source.

Embodiments of kinetic components also include kinetic components operably coupled to at least one timer component. For example kinetic components may be operably coupled to a timer component configured to turn off the kinetic component at a predetermined time.

In certain aspects, all or portion of the kinetic component may be on the interior and/or the exterior of another component of the disclosed device (i.e., the container component).

Kinetic components, in various aspects, attach or affix to other components of the disclosed device (i.e., the container and/or the tumbler). As such, some embodiments of kinetic components include at least one component for coupling to one or more other components of the disclosed device.

The at least one component for coupling at least one component to a kinetic component may have any suitable size or shape (i.e., a circular track or gear having teeth extending therefrom). For example, the at least one component for coupling a tumbler to a kinetic component may be configured to allow the kinetic component to cause the tumbler to move (i.e., rotate) within a container. Additionally, the at least one component for coupling at least one component to a kinetic component may be the same component or a different component for coupling a kinetic component to another separate component.

Embodiments of kinetic components include a wide variety of shapes and sizes including, for example, all possible combinations of the shapes and sizes of various components described herein.

Power Source

Embodiments of the disclosed device include one or more power sources. By “power source”, as used herein, is meant a device that supplies electric power to an electrical load. As such, in some aspects, power sources may include, for example, one or more battery, direct current (DC) power supply, alternating current (AC) power supply, linear regulated power supply, switched-mode power supply, programmable power supply, uninterruptible power supply, high-voltage power supply and/or a voltage multiplier. The amount of power, current and/or voltage associated with a power supply may, for example, be equivalent to that of a common kitchen appliance (i.e., a microwave).

Embodiments of power sources include power sources configured to turn on to provide electrical power to another component and/or turn off to stop providing electrical power to another component. Such power sources may be configured to be turned on and/or off, for example, by operation of a switch, button, timer or other component operably connected to or included in the power source.

A power source may, in certain aspects, be operably connected to one or more components of the disclosed device (i.e., the kinetic component, the UV light source, the timer, etc.). In certain aspects, power sources are connected to at least two components of the disclosed device (i.e., the kinetic component and the UV light source). Embodiments of power sources include electrical connections from a power source to components of the disclosed device. Such electrical connections may include one or more lengths of electrically conductive material (i.e., wire, electrodes).

Embodiments of power sources include a wide variety of shapes and sizes including, for example, all possible combinations of the shapes and sizes of various components described herein. One or more power sources may, in certain aspects, be adhesively, snapedly, hingedly or otherwise connected to one or more components of the disclosed device (i.e., the container). In certain aspects, all or portion of the power source may be on the interior and/or the exterior of another component of the disclosed device (i.e., the container component).

Power sources, in some embodiments, generate or obtain power from renewable energy sources. Renewable energy sources include, for example, one or more systems or devices configured to convert one or more forms of energy (i.e., solar, wind, wave, biofuel, biomass, tidal and/or geothermal energy) to another form (i.e., electric power). For example, a power source may be one or more solar panels.

Timer

The disclosed device, in certain embodiments includes one or more timer. In certain aspects, a timer may be configured to turn one or more other components of the disclosed device on and/or off after a predetermined and/or set amount of time. For example, a timer may be operably coupled to a power source and/or a kinetic component and configured to turn on an/or off the power source and/or kinetic component after a specific length of time.

In certain aspects, a timer may include or be coupled to one or more switches having a first configuration and a second configuration. In some aspects, the timer may be configured to move or change such a switch from the first configuration to a second configuration one or more times. In addition, in some aspects the timer may also be configured to move or change a switch from the second configuration to the first configuration one or more times.

A timer may, in certain aspects, be operably connected to one or more components of the disclosed device (i.e., the kinetic component, the UV light source, the timer, etc.). In certain aspects, timers are connected to at least two components of the disclosed device (i.e., the kinetic component and the UV light source). Embodiments of timers include electrical connections from a timer to components of the disclosed device. Such electrical connections may include one or more lengths of electrically conductive material (i.e., wire).

Timers, in certain embodiments, include timers that may be set or programmed by a user of the disclosed device and/or a manufacturer of the disclosed device. For example, a user may set a timer operably connected to a kinetic component to turn off the kinetic component (i.e., prevent electrical power from reaching the kinetic component) after an amount of time selected by the user. In addition or alternatively, the timer set by the user, or another timer, may be configured or set by a manufacturer of the disclosed device to operate to turn off a UV light source (i.e., prevent electrical power from reaching the UV light source) after the same and/or a different amount of time.

Various embodiments of timers include a wide variety of shapes and sizes including, for example, all possible combinations of the shapes and sizes of various components described herein. One or more timers may, in certain aspects, be adhesively, snapedly, hingedly or otherwise connected to one or more components of the disclosed device (i.e., the container). In certain aspects, all or portion of the timer may be on the interior and/or the exterior of another component of the disclosed device (i.e., the container component).

Alternative device embodiments include, but are not limited to, household food preparation devices, e.g., kitchen devices, that include a UV light source, e.g., as described above. Examples of such devices include, but are not limited to: ovens, e.g., microwave ovens, toaster ovens and regular ovens, blenders, juicers, etc. In addition to the UV light source, the devices may or may not include the additional elements described above, such as the tumbler (e.g., made from UV-transparent materials including (but not limited to) thin plastic, ethylene tetrafluoroethylene, or metal mesh), kinetic element, etc. Aspects of the invention further include methods, e.g., as described below and adapted for such household food preparation devices.

Methods

As summarized above, aspects of the present disclosure also include methods for reducing the microbial load on an object using a UV light source. In certain aspects, methods for reducing the microbial load on an object using a UV light source have steps (e.g., sequential steps and/or simultaneous steps) which include placing an object in a device and tumbling the object in the device while the object is illuminated with UV light.

The phrase “placing an object in a device” is used broadly and generically to refer to introducing and/or inserting one or more objects (e.g., as “objects” are defined herein) into any of the disclosed devices or their components (e.g., container, tumbler, etc.). For example, in some embodiments of the methods, one or more objects is introduced into a device having a container, a UV light source configured to illuminate the interior of the container, and/or a tumbler configured for insertion into the container and comprising at least one UV light transmissive material. In some instances, the object is not washed or rinsed, e.g., with water, prior to placement in the tumbler.

In certain aspects, placing an object in a device includes opening a device or one or more of its components (e.g. one or more doors on a container, one or more lids and/or caps on a tumbler) to expose one or more openings through which the object may be inserted. Opening a device or one or more of its components may include, for example, pulling a lever, pushing a button turning a dial, swinging a door, unscrewing a lid, un-snapping a cap, or any combination thereof. In some aspects, placing an object in a device includes closing (e.g., sealing to air and/or water and/or light) the device or one or more of its components (e.g. one or more doors on a container, one or more lids and/or caps on a tumbler) after an object has been passed through one or more exposed openings. Closing a device or one or more of its components may include, for example, pulling a lever, pushing a button turning a dial, swinging a door, unscrewing a lid, un-snapping a cap, or any combination thereof.

The phrase “tumbling an object in a device” is used broadly and generically to refer to moving one or more objects (e.g., as “objects” are defined above) within any of the devices disclosed herein or their components (e.g., container, tumbler, etc.). For example, tumbling an object in a device includes exerting force on the object using one or more components of a disclosed device (e.g., tumbler, kinetic component) and thereby causing the object to move (i.e., rotate, vibrate, tumble, etc.) within the device.

In certain aspects, one or more objects may be retained within the device while not being moved (i.e., “tumbled”) therein for a period of time. For example, one or more objects may be held in the device in a stationary position during a full or portion of a period of time in which the object is illuminated or a full or portion of a period of time in which the object is not illuminated.

In some aspects, tumbling an object in the disclosed devices may include for example, turning one or more components of the disclosed device on or off. Turning one or more components of the disclosed device on or off may include, for example, causing electrical power to reach or not to reach one or more components of the disclosed device. Tumbling an object in the disclosed devices includes, in some embodiments, pulling a lever, pushing a button turning a dial, swinging a door, unscrewing a lid, un-snapping a cap, or any combination thereof on one or more components of the disclosed devices.

For example, in certain aspects, tumbling an object in the disclosed devices includes pushing at least one button on an exterior surface of a container and/or timer and/or power source which causes the kinetic component to move the tumbler within the container which, in turn, causes an object to move (e.g., move immediately or after a set time) within the tumbler. In certain aspects, tumbling an object in the disclosed devices includes pushing at least one button on an exterior surface of a container and/or timer and/or power source which causes the kinetic component to stop moving the tumbler within the container which, in turn, causes an object to stop moving within the tumbler.

In various aspects, tumbling an object in the disclosed devices may be automatic (i.e., starts and/or stops and/or continues without need for human intervention or manual power, such as may occur with an electric motor). In some aspects, tumbling an object in the disclosed devices may be manual (i.e., starts and/or stops and/or continues only with manual power exerted by a human).

In particular embodiments of the disclosed methods, tumbling at least one object in the disclosed devices includes ventilating the object. In some aspects, ventilating an object means causing air and/or fluid to circulate around the object while the object is moved with the device. Such air and/or fluid is additional to the air and/or fluid present on or around the object when the object is placed in the device or the object starts being moved within the container by a component of the device. In some embodiments, tumbling at least one object in the disclosed devices includes not ventilating the object (i.e., retaining the object in an air and/or water-tight cavity).

Tumbling at least one object in the disclosed devices, in some embodiments, includes illuminating the object with UV light. As such, in some aspects, at least one object is exposed to UV light while the object is moved within the disclosed device or one of its components. In certain embodiments, tumbling an object in the disclosed devices while the object is illuminated with UV light includes pushing at least one button on an exterior surface of a container and/or timer and/or power source which causes the object to start and/or stop being illuminated (e.g., immediately or after a set time) with UV light. In certain embodiments tumbling at least one object in the disclosed devices includes activating (e.g., setting) a timer coupled to at least one UV light source and configured to turn off the at least one UV light source after a predetermined amount of time. In some embodiments tumbling at least one object in the disclosed devices includes activating a timer operatively coupled to at least one kinetic component and configured to turn off the at least one kinetic component after a predetermined amount of time.

One or more objects may, in certain aspects, be moved (e.g., tumbled) within the device for the same amount of time that the object is illuminated with UV light. In certain aspects, one or more objects may be moved (e.g., tumbled) within the device for a longer and/or shorter amount of time that the object is illuminated with UV light.

As noted above, placing an object in a device refers to introducing and/or inserting one or more objects into any of the disclosed devices or components of the disclosed devices, such as a container and/or tumbler. In some embodiments of the methods in which placing an object in a device includes introducing an object into a tumbler, the tumbler is composed of one or more UV light transmissive materials. In certain aspects, the one or more UV light transmissive materials may be composed of a layer (e.g., a solid layer) of material or materials having an exterior surface and an interior surface. In some aspects, an exterior surface of a light transmissive material or materials may be parallel to an interior surface of a light transmissive material or materials. In some embodiments, illuminating one or more objects with UV light includes causing UV light to pass through both an exterior surface and an interior surface of a layer of UV light transmissive material or materials. In some embodiments, illuminating one or more objects with UV light includes emitting light from a source on one side of a UV light transmissive material (e.g., a material having an interior and exterior surface) such that the light passes partially or entirely through the material without diffusing and/or reflecting.

As described above, in certain embodiments, placing an object in a device includes opening a device or one or more of its components (e.g. one or more doors on a container). Embodiments of the disclosed methods also include removing a tumbler from the disclosed device (e.g., removing through an opening exposed by an open door of a container) and repositioning (e.g., opening and/or closing) a lid and/or cap on the tumbler. The methods may include inserting and/or removing one or more objects into or out of the tumbler and/or repositioning (e.g., opening and/or closing) a lid and/or cap on the tumbler. Embodiments of the methods also include introducing or re-introducing a tumbler into the disclosed device (e.g., inserting through an opening exposed by an open door of a container) and/or closing at least one door on a container of the disclosed device.

In certain embodiments, the disclosed methods include eliminating and/or killing an amount (e.g., 99%) of microbial life (e.g., bacteria) present on or in one or more objects. In certain embodiments, the disclosed methods include reducing the microbial load on one or more objects. In certain aspects, the amount of microbial life on or in one or more objects that is killed may be 100% of the total microbial life initially present. The percentage of microbial life killed or eliminated may be 10% or more, 20% or more, 30% or more, 40% or more, 50% or more, 60% or more, 70% or more, 80% or more, 85% or more, 90% or more, 91% or more, 92% or more, 93% or more, 94% or more, 95% or more, 96% or more, 97% or more, 98% or more, 99% or more of the total microbial life initially present.

In various aspects, methods for reducing the microbial load on an object using a UV light source have steps in addition to placing an object in a device and tumbling the object in the device while the object is illuminated with UV light.

Particular embodiments of the methods include insertion of a tumbler into another component (e.g., a container) of the disclosed devices. Embodiments of the methods include removal of a tumbler from another component (e.g., a container) of the disclosed devices. For example, in some aspects, the methods include removal of a tumbler having an object therein from a container of the disclosed device following a period of time in which the object was illuminated with UV light within the container.

Certain embodiments of the methods include consuming (e.g., ingesting as food) at least a portion of one or more objects on which the microbial load has been reduced. For example, the methods may include eating an object or a portion of an object after removing the object from the disclosed device following a period of time in which the object was illuminated with UV light within the tumbler and/or container. In some embodiments, consuming an object includes eating an object after a percentage (e.g., around or at least 99%) of microbial life has been killed and/or eliminated from the object using the disclosed device.

The methods, in some embodiments, include washing the disclosed device or one of its components (e.g., tumbler) using soap and/or water. For example, a tumbler may be washed to remove excess portions of one or more objects following removal of the majority of the one or more objects from the tumbler.

Embodiments of the methods include storing the disclosed device by cleaning and drying some or all of the components of the disclosed device and placing the device in a storage area for a specific amount of time. In some aspects, the components of the disclosed device may be stored separately or each within another.

Utility

The subject devices and methods may be used to reduce the microbial load on one or more objects (e.g., food). Such objects may have a wide variety of types and applications.

In certain embodiments, the objects are plants. In some aspects, plants are of the kingdom Plantae and include green plants (Viridiplantae), leafed plants (e.g., leaf vegetables) and/or non-leafed plants. In particular aspects, plants include cereals, vegetables, spices, fruits, nuts, herbs, and/or flowers. In some aspects, plants include wood.

As described above, the objects, in certain embodiments, are one or more substances that can be consumed to provide nutritional support for the body of the consumer. In some embodiments, the potential consumer may be a mammal such as a human. In such embodiments, the objects are human food. In some embodiments, the potential consumer may be an animal. In such embodiments, the objects are animal food. In some embodiments, the objects include plant matter that is edible by a human.

Plant matter that is edible by a human includes, in some aspects, leafed plants and non-leafed plants. Plant matter that is edible by a human includes, for example, cereals, vegetables, spices, fruits, nuts, herbs, and/or flowers. Plant matter that is edible by a human also includes, for example, salad greens and/or salad vegetables. For example, salad greens and/or salad vegetables include alfalfa, alfalfa sprouts, beans, bean sprouts, lettuce (i.e., leaf, romaine, butterhead, and/or crisphead lettuce), cabbage (i.e., savoy, white, green, and/or red cabbage), carrots, olives, spinach, onions, radishes, apples, avocados, tomatoes, sunflower seeds, dandelions, arugula, peppers, mushrooms, cucumbers, celery, artichoke, heart of palm, and any combination thereof.

Certain aspects of the disclosed device may include objects upon which microbial life, (i.e., bacteria), accumulate. In some embodiments, the objects are household items. For example, such household items may include toys for children, utensils, tweezers, nail-clippers and toothbrushes. In some embodiments, the objects are one or more textiles. In certain aspects in which the objects are one or more textiles, the objects may be one or more clothes for humans. The objects, in certain embodiments, include one or more electronic devices (i.e., remote controls, cell phones, calculators, keyboards, headphones, microphones, computer mice, computer gaming devices, tablet computers, etc.).

As such, the disclosed devices and methods may be applied to eliminate and/or kill all or a portion of microbial life present in or on a wide variety of objects. Reducing the microbial load on an object may make it incapable of causing infection in a subject (i.e., a living organism, such as a human). Accordingly, the disclosed devices and methods may be used to eliminate microbial life potentially harmful to the health of subjects. By eliminating microbial life potentially harmful to the health of subjects, the disclosed devices and methods may be used to reduce pathogens, provide cleaner foods and/or environments for subjects, and to promote the overall health of subjects.

### EXPERIMENTAL

As can be appreciated from the disclosure provided above, the present disclosure has a wide variety of applications. Accordingly, the following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Those of skill in the art will readily recognize a variety of noncritical parameters that could be changed or modified to yield essentially similar results. Thus, the following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for.

Materials and Methods

The following are general materials and protocols used in Examples below.

### Device for Reducing the Microbial Load on an Object Using a UV Light Source

A prototype device for reducing the microbial load on an object using a UV light source was constructed. The prototype device included container, tumbler, lid, and UV light source components as well as a kinetic component.

The prototype device was also configured to reversibly receive an object into the device. The object inserted into the device was edible greens. Such edible greens included plant material from which a human could derive nourishment.

The container of the prototype device had a rectangular box shape. The container of the prototype device had a door that corresponded to and covered one of the six sides of the rectangular box shape of the container. The door of the container was also hingedly connected to the remainder of the container and configured to reversibly swing in an outward and upward direction to expose an opening in the container having a dimension sufficient to receive the tumbler into the container. The surfaces of the interior cavity of the container of the prototype device were composed of or coated with a material that was reflective to UV light. The container was also configured to rotatably couple to the tumbler component.

At least a portion of the tumbler component was composed of a UV light transmissive material. The tumbler was shaped generally as a cylinder having a first end and a second end separated by a substantially tubular body of transmissive material and having a cavity therein. The tumbler had an opening at the first end dimensioned to reversibly receive edible greens into the cavity of the tumbler component. The tumbler also was configured to rotatably couple to the container component.

The prototype device also included a lid component sized and shaped to couple to the first end of the remaining portions of the tumbler and cover the opening in the first end of the tumbler while in a closed configuration. The lid of the prototype device was also configured to be reversibly removed from the remainder of the tumbling component to expose the opening in the first end of the tumbling component dimensioned to receive edible greens.

The UV light source of the prototype device was composed of a plurality of UV light bulbs. The UV light bulbs were constructed to emit electromagnetic radiation having a wavelength associated with UV light. The UV light bulbs were also operatively connected to a power source.

The prototype device also included a kinetic component. The kinetic component was coupled to the container and the tumbler and configured to move (i.e., rotate) the tumbler within the container. The kinetic component was also operatively connected to a power source.

### Example 1

### Efficiency of Device in Killing Endogenous Bacteria

The bacterial load of endogenous bacteria (i.e., bacteria naturally present) on different types of edible greens was individually quantified and recorded. The types of edible greens tested were baby spinach, romaine lettuce and spring mix including baby lettuce and radicchio.

The different types of edible greens were then individually (i.e., at different times) placed inside the tumbler of the prototype device by first removing the lid from the tumbler, inserting the greens and replacing the lid onto the tumbler. The tumbler containing the greens was inserted into the container of the prototype device by first opening the door of the container to expose the opening in the container dimensioned to receive the tumbler, inserting the tumbler into the container and thereafter closing the door of the container. The tumbler was then moved (i.e., rotated) inside the container for a period of time using the kinetic component while the tumbler and the edible greens in the tumbler were illuminated with UV light.

Following the period of movement and illumination, the tumbler was removed from the container by opening the door of the container and removing the tumbler from the container. The edible greens were then removed from the container by removing the lid from the container to expose the opening in the tumbler dimensioned to reversibly receive the edible greens and thereafter removing the edible greens from the container.

The bacterial load on the edible greens was again quantified and recorded. It was observed that the bacterial load on the edible greens was substantially reduced after the illumination process as compared to the bacterial load before the illumination process. Based on the quantified results, the rate of bacterial killing for each salad green was calculated. Specifically, the illumination process using the prototype device was found to kill 99.3% of bacteria present on the baby spinach, 99.4% of the bacteria present on the romaine lettuce and 94.2% of the bacteria present on the spring mix.

### Example 2

### Efficiency of Device in Killing Salmonella Bacteria

Edible greens were spiked with a clinical isolate of Salmonella cultured in the laboratory. The specific type of edible greens tested was spring mix which included baby lettuce and radicchio. Following the application of the Salmonella to the edible greens, the bacterial load on the edible greens was quantified and recorded.

The edible greens were then placed inside the tumbler of the prototype device by first removing the lid from the tumbler, inserting the greens and replacing the lid onto the tumbler. The tumbler containing the greens was inserted into the container of the prototype device by first opening the door of the container to expose the opening in the container dimensioned to receive the tumbler, inserting the tumbler into the container and thereafter closing the door of the container. The tumbler was then moved (i.e., rotated) inside the container for a period of time using the kinetic component while the tumbler and the edible greens in the tumbler were illuminated with UV light.

Following the period of movement and illumination, the tumbler was removed from the container by opening the door of the container and removing the tumbler from the container. The edible greens were then removed from the container by removing the lid from the container to expose the opening in the tumbler dimensioned to reversibly receive the edible greens and thereafter removing the edible greens from the container.

The bacterial load on the edible greens was again quantified and recorded. Using these results, the kill rate of Salmonella was calculated. It was observed that the bacterial load on the edible greens was substantially reduced after the illumination process as compared to the bacterial load before the illumination process. Specifically, it was found that an illumination period of 2 minutes killed 81.4% of Salmonella present on the edible greens. It was also found that an illumination period of 4 minutes killed 91.2% of Salmonella present on the edible greens and that an illumination period of 8 minutes killed 94.3% of Salmonella present on the edible greens.

Based on these results and the results of Example 1, it was reasoned that the kill rate achieved by the prototype device should significantly reduce the pathogen level of bacteria present on an object to below the infectious inoculum of 10 to 100 bacteria (i.e., the number of bacteria needed to cause human diseases).

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims. It is also to be understood that the terminology used herein is for the purpose of describing particular embodiments only, and is not intended to be limiting, since the scope of the present invention will be limited only by the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A device for reducing the microbial load on an object, the device comprising:
a container comprising an interior and an exterior;
a UV light source configured to illuminate at least a portion of the interior of the container; and
a tumbler configured for insertion into the container and comprising a UV light transmissive material.

2. The device according to claim 1, wherein the container comprises at least one UV light-reflective interior surface.

3. The device according to claim 1, wherein the container is shaped as a rectangular box.

4. (canceled)

5. The device according to claim 1, wherein the at least one UV light source is operably coupled to a timer component configured to turn off the UV light source after a predetermined time.

6. The device according to claim 1, further comprising a kinetic component configured to move the tumbler within the container.

7-13. (canceled)

14. The device according to claim 1, wherein the tumbler further comprises at least one opening.

15. The device according to claim 14, wherein the tumbler further comprises a lid removably coupled to the tumbler and configured to at least partially cover the at least one opening in the tumbler.

16. The device according to claim 15, wherein when the lid is coupled to the tumbler, the lid and tumbler form a water-tight cavity within the tumbler.

17. The device according to claim 1, wherein the tumbler is shaped as a cylinder having a first end and a second end and a long axis of symmetry extending from the first end to the second end and about which the tumbler is symmetrical.

18-21. (canceled)

22. The device according to claim 1, wherein the tumbler has an open configuration and a closed configuration.

23. The device according to claim 22, wherein when the tumbler is in a closed configuration, the tumbler forms a water-tight cavity within the tumbler.

24. The device according to claim 1, further comprising a power source operably connected to the at least one UV light source.

25. The device according to claim 1, wherein the device is configured to be lifted by an average adult human.

26. The device according to claim 1, wherein the tumbler comprises an exterior surface and a single continuous interior surface defined by a solid sheet of the UV light transmissive material.

27. The device according to claim 1, wherein the tumbler comprises a polymer.

28. The device according to claim 27, wherein the tumbler comprises ethylene tetrafluoroethylene.

29. The device according to claim 1, wherein the object is edible plant matter.

30. The device according to claim 1, wherein the container further comprises a door configured to have an open configuration and a closed configuration.

31. The device according to claim 30, wherein when the door is in an open configuration, the interior of the container is accessible.

32. A method of reducing the microbial load on an object comprising:
placing an object in a device comprising:
a container;
a UV light source configured to illuminate the interior of the container; and
a tumbler configured for insertion into the container and comprising
a UV light transmissive material; and
tumbling the object in the device while the object is illuminated with UV light.

33-37. (canceled)
